(19) United States
(12) Patent Application Publication
(10) Pub. No.: US 2010/0004935 A1
(43) Pub. Date: Jan. 7, 2010

(54) Method for issuing a gift card or other prepaid card providing a personalized message created by the provider for the recipient

(76) Inventor: Amir Wain, Redwood Shores, CA (US)

Correspondence Address: WHITE-WELKER & WELKER, LLC, P.O. BOX 199, CLEAR SPRING, MD, 21722-0199, US

(21) Appl. No.: 12/165,713

(22) Filed: Jul. 1, 2008

(51) Int. Cl. G10L 11/00

(52) U.S. Cl. 704/272; 704/E11.001

(57) ABSTRACT

The present invention is a method for issuing a gift card or other prepaid card whether it be an open or closed card type. Upon activation, the personalized service provides a voice or AV message that was created on behalf of or by the provider for the receiver. The personalized message is not imprinted on the card, but is delivered by voice mail, website, download to phone, or visiting a website.

### CROSS REFERENCE TO RELATED APPLICATIONS

This application claims priority from U.S. Provisional Patent Application Ser. No. 61/033,809, entitled “A method for issuing a gift card or other prepaid card providing a personalized message created by the buyer for the recipient”, filed on Mar. 5, 2008.

### FEDERALLY SPONSORED RESEARCH

Not Applicable

### SEQUENCE LISTING OR PROGRAM

Not Applicable

### TECHNICAL FIELD OF THE INVENTION

The present invention relates generally to cards including gift cards, prepaid cards incentive cards, rebate cards whether used in a closed loop or open loop environment. More specifically, the present invention relates to prepaid cards and gift cards with features including the ability to provide a personalized message created by or on behalf of the provider, an individual or a corporation, for the recipient.

### BACKGROUND OF THE INVENTION

Prepaid cards and gift cards and other financial transactions cards come in many forms. A gift card, for example, is a type of stored-value card that includes pre-loaded or selectively loaded monetary value. In one example, a customer buys a gift card having a specified value for presentation as a gift for another person. In another example, a customer is offered a gift card as an incentive to make a purchase by a business entity. A gift card, like other stored-value cards, can be “recharged” or “reloaded” at the direction of the bearer. The balance associated with the card declines as the card is used, encouraging repeat visits to the retailer or other provider issuing the card. Additionally, the card generally remains in the user's purse or wallet, serving as an advertisement or reminder to revisit the associated retailer. Gift cards provide a number of advantages to both the consumer and the retailer.

As a result of their appeal, many retailers have begun to offer and sell prepaid cards and gift cards. Since a relatively large selection of prepaid cards and gift cards can be stocked and displayed without requiring significant retail floor space, retailers can enjoy maximized revenues relative to small sections of their leased or owned storefronts. Despite the appeal of prepaid cards to both users and retailers, such market acceptance has created serious problems for providers of prepaid cards and gift cards. In particular, providers of prepaid cards and gift cards have been forced to distinguish their products in order to effectively compete. To date, there are no effective ways to distinguish one's prepaid cards and gift cards from another.

U.S. Pat. No. 7,082,469 teaches a system and method to send dedications of popular songs through a communications medium such as the Internet. A sender contacts a musical jukebox Web site and selects a song to dedicate and enters a recipient's electronic mail (email) address. The sender is given a phone number and Personal Identification Number (PIN). The sender calls the phone number, enters the PIN, and leaves a voice message to introduce the dedication. An email is sent to the recipient's email address containing a Uniform Resource Locator (URL) as a link to a dedication Web page. Retrieval of the dedication Web page causes retrieval of a dedication file containing URLs pointing to the voice dedication and the dedicated song. The URLs are extracted from the dedication file and used to play back the voice dedication and the dedicated song.

U.S. Pat. No. 7,024,807 teaches a combination greeting card and gift card with a coded information portion is provided to be sold and delivered to a recipient as a unit. The greeting card includes preprinted indicia preferably corresponding to a particular occasion such as a birthday, holiday, graduation or other celebretory event. The coded information portion of the gift card preferably includes a PIN number or a scannable portion which, when an account in a remote computer corresponding to the coded information and the gift card is activated, enables the holder of the gift card to obtain goods or services by access to credit corresponding to the card from a remote database. The gift card is initially temporarily coupled to the greeting card by adhesive, tabs and slits, or a mechanical fastener, and concealed when the front and rear panels of the greeting card are in a closed, substantially parallel orientation.

U.S. Pat. No. 6,718,013 teaches an audio message recording and playback system including a recorder-imprinter device, a self-contained voice module for playback of an audio message and a number of input devices for initially recording the audio message to the recorder-imprinter device.

U.S. Pat. No. 6,011,833 teaches a service enabling a sending party to arrange through use of an organization offering this service for physical delivery of a gift such as a bouquet of flowers to a receiving party, the gift being accompanied by a card which directs the receiving party to receive by telephone a recorded personalized message from the sending party.

U.S. Pat. No. 7,266,533 teaches a method for creating an electronic greeting card enclosing an electronic gift is disclosed. In one step, the electronic greeting card selection is received from a sender along with a selection of at least one of a type of electronic gift, an amount for the electronic gift, and an identifier for a receiver of the electronic gift. Payment for the electronic gift is received from a money handler chosen by the sender. A code indicative of the electronic gift is received, whereby the code facilitates redemption of the electronic gift. The code is embedded in the electronic greeting card.

U.S. Pat. No. 7,130,817 teaches a method for creating an electronic greeting card that references a gift is disclosed. In one step, a selection of the electronic greeting card is received from a sender of that greeting card. Identification of the gift is received. A code indicative of the gift is created, whereby the code facilitates retrieving information about the gift. The code is embedded in the electronic greeting card.

U.S. Pat. No. 5,251,251 teaches a subscriber's personalized voice message to be played out to a recipient is recorded by a central facility over a telecommunications network. The subscriber selects a prerecorded message from a library of messages, and is assigned an access code associated with both the personalized and prerecorded messages. A greeting card bearing the access code is mailed by the subscriber to the recipient who will call the facility, enter the access code and hear the personalized and subscriber-selected messages played out in succession. The library of messages preferably contains prerecorded voice messages of celebrities or professional celebrity impersonators.

U.S. Pat. No. 4,557,041 teaches a system for producing voice message keepsakes includes a message processor which may be accessed over a plurality of communication links, such as telephone lines. The processor may be so accessed by a customer's communication set, such as a conventional telephone set, or by a subscriber set, and it is capable of distinguishing the two. When accessed by a customer's set, the processor permits the caller to create a temporary mailbox associated with his gift purchase, in which he may then record a voice message. When called by a subscriber set, the processor permits previously created mailboxes to be accessed and will transfer the message recorded therein to the subscriber set. The subscriber set includes a receptacle for receiving a voice message keepsake in accordance with the present invention, and it will record thereon stored messages provided from the message processor, under control of the message processor. The invention also contemplates a unique construction for the . . . .

U.S. Pat. No. 5,490,206 teaches a system for producing voice message keepsakes includes a message processor which may be accessed over a plurality of communication links, such as telephone lines. The processor may be so accessed by a customer's communication set, such as a conventional telephone set, or by a subscriber set, and it is capable of distinguishing the two. When accessed by a customer's set, the processor permits the caller to create a temporary mailbox associated with his gift purchase, in which he may then record a voice message. When called by a subscriber set, the processor permits previously created mailboxes to be accessed and will transfer the message recorded therein to the subscriber set. The subscriber set includes a receptacle for receiving a voice message keepsake in accordance with the present invention, and it will record thereon stored messages provided from the message processor, under control of the message processor.

U.S. Pat. No. 5,425,078 teaches a system for producing voice message keepsakes includes a message processor which may be accessed over a plurality of communication links, such as telephone lines. The processor may be so accessed by a customer's communication set, such as a conventional telephone set, or by a subscriber set, and it is capable of distinguishing the two. When accessed by a customer's set, the processor permits the caller to create a temporary mailbox associated with his gift purchase, in which he may then record a voice message. When called by a subscriber set, the processor permits previously created mailboxes to be accessed and will transfer the message recorded therein to the subscriber set. The subscriber set includes a receptacle for receiving a voice message keepsake in accordance with the present invention, and it will record thereon stored messages provided from the message processor, under control of the message processor. The invention also contemplates a unique construction or the . . . .

U.S. Pat. No. 5,444,767 teaches systems and methods for recording and delivering personalized audio messages are provided. The system includes a central facility computer system (CF), a store front programming system (SFS), and a portable playback device (PPD). When a customer desires to send a personalized message to another person, the customer communicates via a telecommunications channel with the CF. Under control of a CF processor, a outgoing message module of the CF provides instructions to the customer, who enters required information and provides the personalized audio message. The personalized audio message is digitized by a CF voice digitizer and transmitted from the CF via a data interface to the SFS. The SFS receives the digitized personalized audio message data from the CF and uses its playback device programmer to program data representing the audio message onto the PPD. The PPD is an audio chip having a nonvolatile memory, an external switch, a battery and a speaker.

U.S. Pat. No. 5,828,732 teaches a gift article voice greeting system connected to a telecommunications network. The system having a message recording apparatus for recording voice messages from subscribers to the telecommunications network, a message replaying apparatus for replaying the voice messages to recipients, and an access control device to interface with the telecommunications network and connect a subscriber calling via the telecommunications network to the message recording apparatus. The access control device is adapted to generate an assigned unique password for each message recorded by the message recording apparatus and include a sound generator to transmit the assigned password to the subscriber. The access control device is further adapted to connect a recipient calling via the telecommunications network to the message replaying apparatus after the subscriber has given the previously assigned password to replay the message to the recipient.

U.S. Pat. No. 7,145,989 teaches a system and a method for recording a personal greeting associated with a pre-paid telephone calling card. The system and method include and involve a data storage system for storing data corresponding to a pre-paid telephone calling card and a personal greeting. Also included and involved is a pre-paid telephone calling card processing system that is coupled to the data storage system and which is configured to receive a request to record the personal greeting during a setup call over a telephone network and to cause the personal greeting to be recorded for subsequent playback. The pre-paid telephone calling card processing system is also configured to receive a request to make an outbound telephone call in relation to the pre-paid telephone calling card during an access call over the telephone network and to cause the personal greeting to be played back automatically during the access call.

U.S. Pat. No. 7,180,990 teaches a system and method for recording at least one message to be associated with a prepaid telephone calling card. The system and method include and involve a data storage system for storing data corresponding to the prepaid telephone calling card and at least one message. Also included and involved is a prepaid telephone calling card processing system that is coupled to the data storage system and configured to receive a request to record the message(s) during a service setup call over a telephone network and to cause the message(s) to be recorded for subsequent playback. The prepaid telephone calling card processing system may also be configured to receive a request to play the message(s) stored in relation to the prepaid telephone calling card during an access call over the telephone network and to cause the message(s) to be played back automatically.

What is needed is a method for distinguishing prepaid cards and gift cards from other providers that can be applied without respect to pricing or branding.

What is needed is a method for providing a personalized attachment to prepaid cards and gift cards that can be created by a purchaser and received by a recipient.

### SUMMARY OF THE INVENTION

The present invention is a method for issuing a gift card or other prepaid card whether it be an open or closed loop card type. Upon activation, the personalized service provides a voice or AV message that was created by or on behalf of the provider for the receiver. The personalized message is not imprinted on the card, but is delivered by voice mail, website, download to phone, or visiting a website or by playback mechanism built into the card.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method of one embodiment of the present invention.

### DETAILED DESCRIPTION OF THE INVENTION

In the following are detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a method for issuing a gift card or other prepaid card, whether it be an open card type such as those provided by payment networks such as Visa and MasterCard or closed loop card type such as those provided by large retailers, that provides means for recording at least one message associated with a prepaid card or gift card. Upon activation, the personalized service provides a voice or AV message that was created on behalf of or by the provider for the receiver. The personalized message is not imprinted on the card, but is delivered by voice mail, website, download to phone, or visiting a website or playback using playback capabilities built into the card.

In practice the provider has the option to leave a written message, which is typically not delivered in their own hand writing, but may be delivered in their own handwriting if uploaded to the system from that own computer or mobile electronic device in the proper format for delivery upon request by the recipient by voice mail, website, download to phone, or visiting a website.

More commonly, a provider has the option to leave a personal voice message that may be retrieved by the recipient. The voice message is a recoding of the provider's own voice and is delivered to the recipient by voice mail, website, download to phone, or visiting a website.

In a consumer embodiment, the present invention allows consumers to record a personalized greeting or message that the card recipient will hear when activating the card. A consumer first buys an enabled gift card, then calls the service and records a personalized message. Next, the provider sends the gift card to the recipient. Upon receipt of the gift card by the recipient, the recipient calls the service to activate the card and is delivered a personalized message from the consumer.

The consumer gift card of the present invention differentiates itself from other cards known in the prior art by providing a competitive advantage via increased customer loyalty, providing means to record a greeting for one card or for multiple cards providing personalized messages Additionally, the electronic embodiment provides the ability to add a personal greeting to a gift card greatly enhancing the appeal of the gift card and adding enjoyment to those giving the card as well as those receiving the gift.

In a commercial embodiment, the present invention allows a single, personalized greeting or message to be recorded and broadcast to multiple gift card recipients. All recipients will hear the message when the card is activated. First, a card giver sets up a “group” and obtains a group ID number. Next, the card giver records the broadcast message and then the cards are shipped in bulk to the recipients. Multiple recipients receive the gift cards. When they call to activate the card all recipients hear the same personalized greeting.

The commercial gift card of the present invention differentiates itself from other cards known in the prior art by providing a competitive advantage via increased customer loyalty, workforce incentive and employee rewards. The commercial gift card embodiment also provides means to record a greeting for multiple cards, providing personalized messages that can be distributed to a group. Finally, the electronic embodiment provides the ability to add a personal greeting to a gift card greatly enhancing the appeal of the gift card and adding enjoyment to those giving the card as well as those receiving the gift.

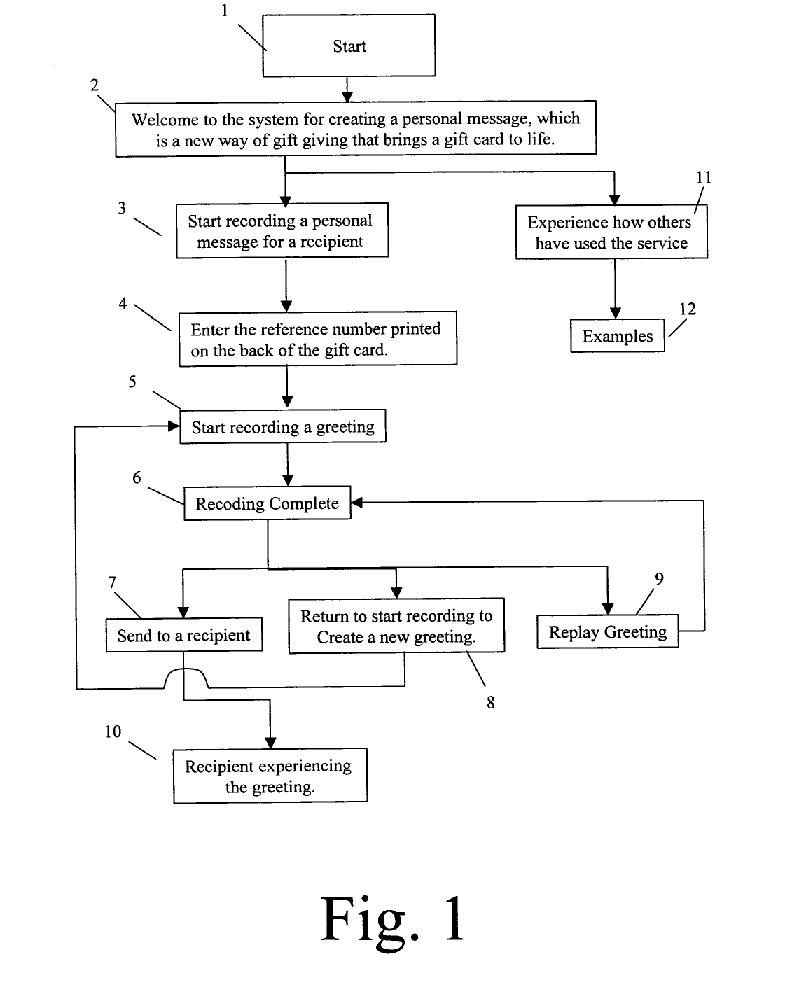

Now referring to FIG. 1, a flow chart illustrating the method of one embodiment of the present invention is shown. The process starts 1 with a welcome to the system 2 for creating a personal message, which is a new way of gift giving that brings a gift card to life. The recipient of the gift card will hear the personal message when they activate the gift card. A provider can record their personal message in any language, sing a song, read a poem or tell a joke. The provider's personal message can be romantic, sentimental or just plain silly, imagination be their guide! As with other phone systems, a prompt for English or Spanish is provided. If an invalid option is selected three times the call will be routed to a customer service representative. If no option is selected after three prompts, English will be selected as default language and the IVR will announce the next menu options. Additionally, users may elect to experience how others have used the service 11 and hear examples 12 of others messages.

To start recording a personal message for a recipient, a provider first presses the appropriate number to select that option 3. The provider then is required to enter the reference number printed on the back of the gift card, followed by the pound key 4 and it is time to record you're their personal message 5. A provider begins recording their personalized message when they hear a tone. When the provider has finished, they press the pound key. If the provider is satisfied with their personal message, they select the appropriate number, send it to the recipient 7, and it will come to life when the card is activated by the recipient 10. If they are not satisfied with their personal message, the provider may select a different option to record a new personal message 8. Additionally, the provider has the option of hearing their message 6 before acceptance and distribution to a recipient and may hear it again 9 as desired.

In a preferred embodiment, the method of the present invention is practiced between consumers, but in an alternative embodiment corporations may use it as well in business to consumer transactions and communications. The business to consumer applications are applied to incentive cards, rebate cards, sample cards, etc. In each one of these cases a personalized message is recorded by the business and is played or retrievable upon activation by the consumer. The personalized message can take many forms. For example, the personalized message may include notice of upcoming sales or new product release. The personalized message may include an apology for products or services that were delivered but did not perform or meet the consumer's expectations. This personalized message may also include lookup of certain info from a database when the system of the present invention is recorded on computer-readable medium and capable of execution by a computer for recording and delivering at least one message associated with a prepaid card or gift card including a web server, a web portal interface, a multi-user network, and an application server.

In an alternative embodiment, a provider has the ability to record the message and playback the message on the card itself. The card is provided with sound recording and playback capabilities in it.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for recording at least one message associated with a prepaid card or gift card, comprising the steps of:
providing a prepaid card to a provider;
customizing the card;
recording a personalized message;
sending the card to a receiver;
receiving the card by the receiver;
delivering the prepaid card to the receiver;
providing a voice or audio visual message to the receiver; and
delivering the message by voice mail, website, download to phone, or visiting a website.

2. The method for recording at least one message associated with a prepaid card or gift card of claim 1 further comprising the step of:
activating the card at the time of purchase.

3. The method for recording at least one message associated with a prepaid card or gift card of claim 1 further comprising the step of:
activating the card by the recipient upon receipt or delivery of the card.

4. The method for recording at least one message associated with a prepaid card or gift card of claim 1 wherein the prepaid card is an open card type.

5. The method for recording at least one message associated with a prepaid card or gift card of claim 1 wherein the prepaid card is closed card type.

6. The method for recording at least one message associated with a prepaid card or gift card of claim 1 wherein the personalized message is stored on the prepaid card.

7. The method for recording at least one message associated with a prepaid card or gift card of claim 1 wherein a written message may be recorded and delivered.

8. The method for recording at least one message associated with a prepaid card or gift card of claim 1 wherein a voice or audio video message is a recoding of the provider's own voice or likeness.

9. The method for recording at least one message associated with a prepaid card or gift card of claim 1 further comprising the additional steps of:
setting up group of recipients;
obtaining a group ID number;
recording a single, personalized message to a plurality of prepaid card recipients;
shipping a plurality of prepaid cards to a plurality of recipients;
receiving the prepaid cards by a plurality of recipients;
activating of the cards by the recipients; and
providing a single, personalized message to the receivers during activation.

10. The system for recording and delivering at least one message associated with a prepaid card or gift card of claim 1 wherein, the card is provided with means providing sound recording and playback capabilities so that the personalized message may be delivered by prepaid card itself.

11. The method for recording at least one message associated with a prepaid card or gift card of claim 1 wherein a provider produces one or more cards.

12. The method for recording at least one message associated with a prepaid card or gift card of claim 1 wherein a provider purchases one or more cards.

13. A system for recording and delivering at least one message associated with a prepaid card or gift card, comprising:
a phone service providing means for a user to call and create a personalized message, associated with one or more prepaid cards, for storage and retrieval at a later time;
if an invalid option is selected three times the call will be routed to a customer service representative;
to start recording a personal message for a recipient, a user first presses the appropriate number to select that option;
the user is then required to enter the reference number printed on the back of the gift card, followed by the pound key and it is time to record the personal message;
a user begins recording their personalized message when they hear a tone;
when finished, they press the pound key;
the user has the option of hearing their message before acceptance and distribution to a recipient;
if the user is satisfied with their personal message, they select the appropriate number and send it to the recipient; and
if they are not satisfied with their personal message, the user may select a different option to record a new personal message;
upon receipt of the prepaid card by a received, the receiver calls the phone service, enters the reference number, and is delivered the personalized message.

14. The system for recording and delivering at least one message associated with a prepaid card or gift card of claim 9 wherein,
the system is recorded on computer-readable medium and capable of execution by a computer for recording and delivering at least one message associated with a prepaid card or gift card, further comprising:
a web server;
an application server;
a web portal interface;
a multi-user network;
said web server provides means for a user to access the system and create a personalized message, associated with one or more prepaid cards, for storage and retrieval at a later time;
to start recording a personal message for a recipient, a user first access the web server via a multi-user network and selects that option;
the user is then required to enter the reference number printed on the back of the gift card, and it is time to record the personal message;
a user begins recording their personalized;
the user has the option of hearing their message before acceptance and distribution to a recipient;
if the user is satisfied with their personal message, they send it to the recipient; and
if they are not satisfied with their personal message, the user may record a new personal message;
upon receipt of the prepaid card by a received, the receiver access the system via the multi-user network, enters the reference number, and is delivered the personalized message.

15. The system for recording and delivering at least one message associated with a prepaid card or gift card of claim 10 wherein, the personalized message may be in a users own handwriting if uploaded to the system.

16. The system for recording and delivering at least one message associated with a prepaid card or gift card of claim 10 wherein, the personalized message may be delivered by voice mail, website, download to phone, or visiting the web server.

17. The system for recording and delivering at least one message associated with a prepaid card or gift card of claim 10 wherein, the card is provided with means providing sound recording and playback capabilities so that the personalized message may be delivered by prepaid card itself.

18. The system for recording and delivering at least one message associated with a prepaid card or gift card of claim 14 wherein,
the card is activated at the time of purchase.

19. The system for recording and delivering at least one message associated with a prepaid card or gift card of claim 14 wherein,
the card is activated by the recipient upon receipt or delivery of the card.
